(19) United States
(12) Patent Application Publication
(10) Pub. No.: US 2007/0058559 A1
(43) Pub. Date: Mar. 15, 2007

(54) Method and system of assigning priority to detection messages

(75) Inventor: Shugong Xu, Vancouver, WA (US)

Correspondence Address: MICHAEL BLAINE BROOKS, PC, P.O. BOX 1630, SIMI VALLEY, CA, 93062-1630, US

(73) Assignee: Sharp Laboratories of America, Inc.

(21) Appl. No.: 11/364,431

(22) Filed: Feb. 27, 2006

Related U.S. Application Data
(60) Provisional application No. 60/717,883, filed on Sep. 15, 2005.

(51) Int. Cl. H04J 1/16

(52) U.S. Cl. 370/252

(57) ABSTRACT

The embodiments of the present invention provides for methods, devices, and systems for proximity detection, typically between transmitting devices and receiving devices. The various embodiments of proximity detection may be typically applied any priority-based networks. The round trip time control messages are typically set at a highest priority or at a priority at least one higher than the associated content.

### CROSS-REFERENCE TO RELATED APPLICATIONS

This application claims the benefit of U.S. Provisional patent Applications Ser. No. 60/717,883 filed Sep. 15, 2005, entitled “Method and System of Assigning Priority to Detection Messages,” which is hereby incorporated by reference herein in its entirety including all appendixes for all purposes.

### BACKGROUND

The embodiments of the present invention relate to proximity detection, particularly to proximity detection of network control messages. In some digital content protection schemes, one way of ensuring that digital content, e.g., a movie or song, is not illegally transmitted, for example, from a home network to the Internet is by incorporating proximity detection, i.e., localizing the content.

In a Wi-Fi Multimedia (WMM) wireless local area network (WLAN), for example, proximity detection challenges may be unreasonably denied. For example, WWM currently defines four access categories (ACs), i.e., priorities, and enables contention free bursts (CFB) for WLAN enforcing quality of service (QOS). Stations in this WLAN may perform CFB transmissions within its transmission opportunity (TXOP), i.e., transmission without contention. This results in having other WLAN stations with the same priority traffic to wait until the transmission is complete before trying to compete for access in the WLAN channel.

Typically, there is a different CFB TXOP time limit for each available access category. The default TXOP limit, for example, for one access category, AC_V1, is 6.016 ms for IEEE 802.11b and 3.008 ms for IEEE 802.11a and 802.11g. This may entail having a one-way traffic be delayed for as much as approximately 6 ms for networks implementing 802.11b or 3 ms for networks implementing 802.11a or 802.11g. Considering these time limits, a round trip or two-way traffic may end up larger than a determined threshold, e.g., greater than the exemplary 7 ms delay threshold currently defined in some digital protection schemes. In conventional or traditional systems, the proximity detection traffic is typically transmitted as best effort. In one simulation experiment, approximately more than seventy-eight percent (78%) of the best effort packets experienced more than 10 ms one-way delay in a 36 Mbps WMM 11a WLAN, when there were 3 video traffics of seven (7) Mbps. Approximately ninety-six percent of the best effort packets also have a one-way delay higher than 3.5 ms. This means the probability of failing a proximity detection test is higher, particularly in some network architectures.

### SUMMARY

In some embodiments of the invention, a method of proximity detection is provided. The method includes the steps of determining a priority of an associated content; sending at least one initial round trip time (RTT) control message indicating initiation of a proximity test, wherein the sending of the initial RTT control message is at an RTT priority; and sending at least one response RTT control message, indicating completion of the proximity test, in response to at least one of the initial RTT control messages, wherein the sending of the response RTT control message is at the RTT priority. The RTT priority is based on the determined associated content priority.

In other embodiments of the invention, another method of proximity detection is provided. The method includes the steps of sending at least one initial round trip time (RTT) control message indicating initiation of a proximity test, wherein the sending of the initial RTT control message is at a highest priority; and sending at least one response RTT control message, indicating completion of the proximity test, in response to at least one of the initial RTT control messages.

In other embodiments of the invention, another method of proximity detection is provided. The method includes the steps of assigning a highest priority to a port via which RTT control messages are transmitted; sending at least one initial round trip time (RTT) control message indicating initiation of a proximity test via the port; and sending at least one response RTT control message, indicating completion of the proximity test, in response to the at least one of the initial RTT control messages.

In other embodiments of the invention, a source device, adapted to be operably coupled with at least one receiving device (RX) via a network segment, is provided. The device includes a transmit content module, a round trip time (RTT) test module, and a priority module. The transmit content module is adapted to transmit at least one content element, associated with a proximity test, to the at least one RX. The RTT test module is adapted to transmit at least one initial RTT control message indicating initiation of the proximity test; receive at least one response RTT control message in response to the at least one initiate RTT control message, the at least one response RTT control message indicating completion of the proximity test; and determine at least one RTT based on the at least one transmitted initiate RTT control message and the at least one received response RTT control message. The priority module is adapted to determine at least one priority with which the RTT test module is adapted to transmit the at least one initiate RTT control message, wherein the at least one priority is based on a content priority of the at least one content associated with the proximity test.

In other embodiments of the invention, a source device, adapted to be operably coupled with at least one receiving device (RX) via a network segment, is also provided. The device includes at least one port assigned a highest priority, a round trip time (RTT) test module, and a transmit content module. The RTT test module is adapted to transmit at least one initiate RTT control message, indicating initiation of a proximity test, via the at least one port; receive, via the at least one port, at least one response RTT control message, indicating completion of the proximity test, in response to the at least one initiate RTT control message; and determine at least one RTT based on the at least one transmitted initiate RTT control message and the at least one received response RTT control message. The transmit content module is adapted to transmit at least one content to the at least one RX based on whether the determined at least one RTT is within a defined RTT condition.

In other emdodiments, a source device, adapted to be operably coupled with at least one receiving device (RX) via a network segment, is also provided. The device includes a transmit content module and a RTT test module. The transmit content module is adapted to transmit at least one content element, associated with a proximity test, to the at least one RX. The RTT test module is adapted to transmit, at a highest priority, at least one initiate RTT control message indicating initiation of the proximity test; receive at least one response RTT control message in response to the at least one initiate RTT control message, the at least one response RTT control message indicating completion of the proximity test; and determine at least one RTT based on the at least one transmitted initiate RTT control message and the at least one received response RTT control message.

In some other embodiments of the invention, a receiving device, adapted to be operably coupled with at least one transmitting device (TX) via a network segment, is also provided. The device includes a receive content module and an RTT test module. The receive content module is adapted to receive at least one content element from the at least one TX, wherein the at least one content is associated with a proximity test. The RTT test module is adapted to receive at least one initiate RTT control message indicating initiation of the proximity test at an RTT priority, wherein the RTT priority is based on a content priority of the content associated with the proximity test; and transmit at the RTT priority at least one response RTT control message, indicating completion of the proximity test, in response to at least one of the received RTT control messages.

In some other embodiments, a receiving device, adapted to be operably coupled with at least one transmitting device (TX) via a network segment is provided. The device includes a receive content module and an RTT test module. The receive content module is adapted to receive at least one content element from the at least one TX, wherein the at least one content is associated with a proximity test. The RTT test module is adapted to receive at least one initiate RTT control message indicating initiation of the proximity test, wherein the at least one initiate RTT control message is transmitted via a first port, of the at least one TX, with a first priority; transmit at the first priority, at least one response RTT control message, indicating completion of the proximity test, in response to the at least one received RTT control message; and wherein the first priority is selected from at least one of the following: a highest priority; and a priority higher than a priority of the associated content.

### BRIEF DESCRIPTION OF THE DRAWINGS

The present invention is illustrated by way of example and not limitation in the figures of the accompanying drawings, and in which:

FIG. 1 is a high-level block diagram of an exemplary data communication system according to an embodiment of the invention;

FIG. 2 is a high-level block diagram of a source/transmitting device and a sink/receiving device, according to an embodiment of the invention;

FIG. 3 is a high-level flowchart in which priorities of proximity control messages may be set, according to an embodiment of the invention;

FIG. 4 is an exemplary diagram illustrating proximity or round trip time control messages exchanged between a source and a sink, according to an embodiment of the invention;

FIG. 5 is a high-level functional block diagram of an exemplary source or transmitting device, according to an embodiment of the invention; and

FIG. 6 is a high-level functional block diagram of an exemplary sink or receiving device, according to an embodiment of the invention.

### DETAILED DESCRIPTION

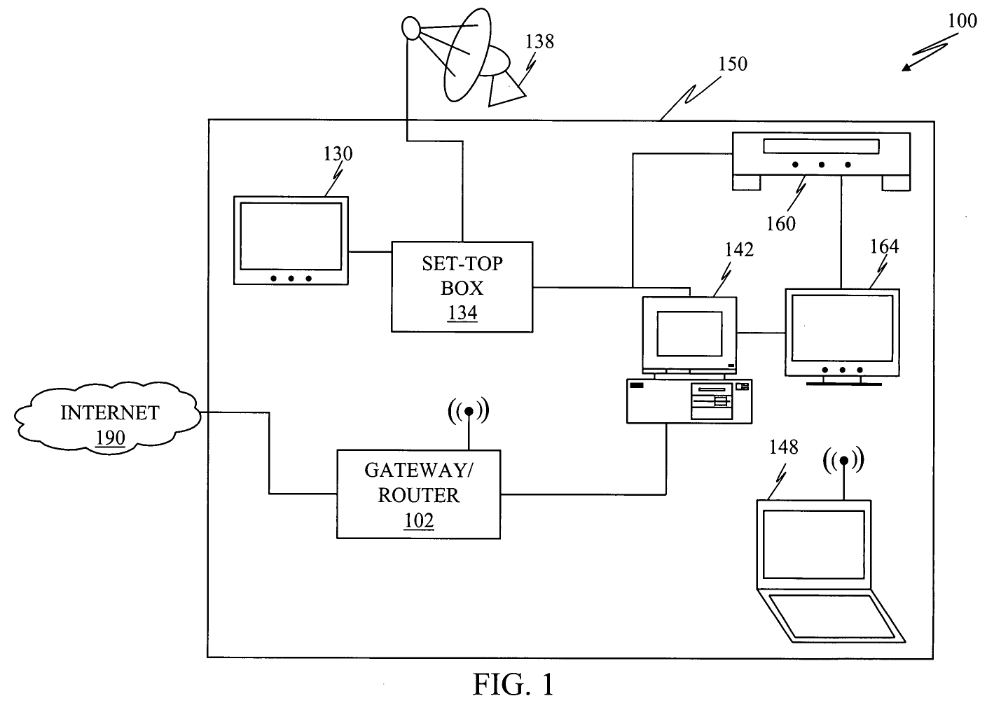

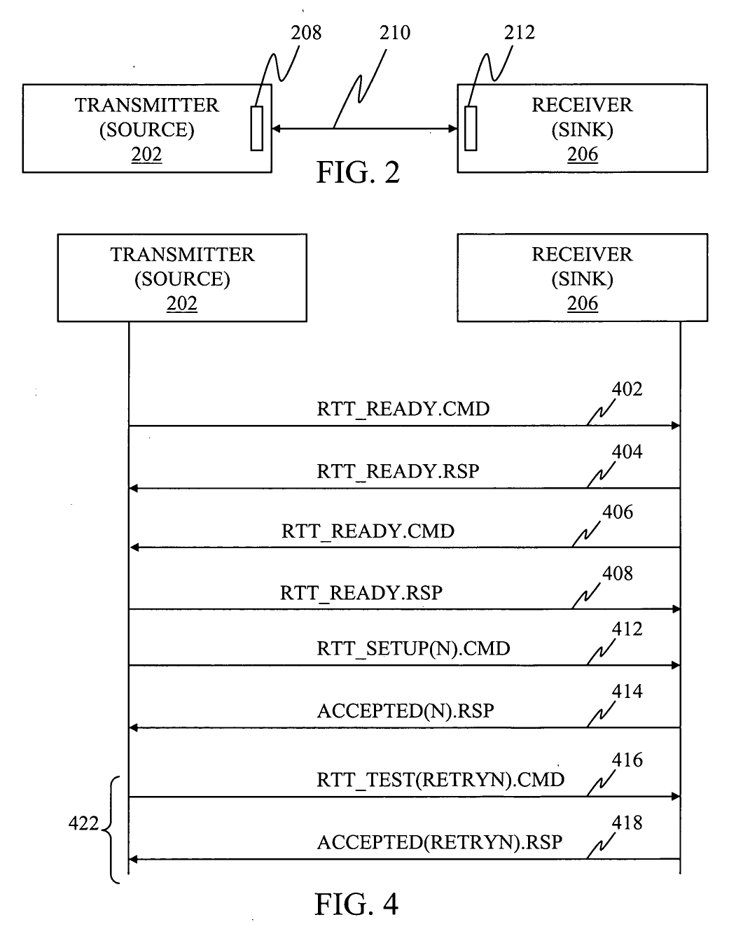

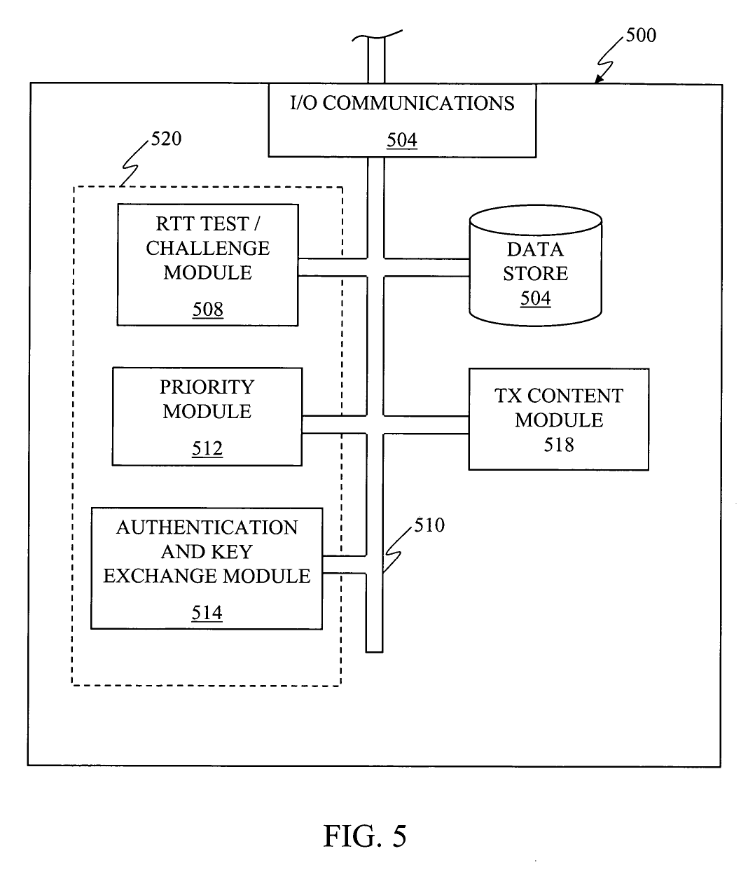

To better understand the figures, reference numerals within the one hundred series, for example, 134 and 190, are initially introduced in FIG. 1, reference numerals in the two hundred series, for example, 202 and 206, are initially introduced in FIG. 2, and so on and so forth. So, reference numerals in the five hundred series, e.g., 504 and 512, are initially introduced in FIG. 5.

Protection of digital data from unauthorized copying and distribution is a concern for intellectual property owners and controllers. This concern is of increasing importance as consumers now desire to move digital content between digital devices. Consumers, for example, may desire to move video contents between their personal computers (PCs), digital video or versatile disc (DVD) players, set-top boxes, and digital televisions (DTVs). One standard or framework currently being developed and established is digital transmission content protection (DTCP). DTCP generally is a digital output protection technology that employs a cryptographic protocol to protect various types of audio and video content from unauthorized copying, interception, and tampering as it is transmitted or transported via digital interfaces or medium. Such digital interfaces may include, but are not limited to, physical interfaces, both wireless and wired, such as universal serial bus (USB), Op-iLink, media oriented systems transport (MOST), internet protocol (IP), Ethernet, 802.11, and IEEE 1394. These digital interfaces typically are bi-directional communication interfaces. One way of ensuring copy protection is by localizing the transmission or distribution of these protected contents, i.e., constraining the transfer of protected content within a home and personal network space, i.e., a local or an approximate local environment, thereby preventing anonymous, unauthorized, “hot-spot”—based sharing of content and unauthorized downloading to the Internet. The embodiments of the present invention reside, in part, in the recognition of the problems due to proximity detection challenges, and, in part, in providing a solution thereto.

FIG. 1 is an exemplary diagram of a communication network architecture 100 wherein digital content, such as audio and video, are transmitted according to some embodiments of the invention. In this exemplary embodiment, a home or local network 150 includes a number of consumer electronics, including a set-top box 134, digital television (DTV) 130, a personal computer (PC) 142, a digital video or versatile disc (DVD) player 160, a monitor 164, and a wireless computer laptop 148, connected via various network links or segments. These network segments, for example, may include wired and/or wireless network segments. Such network segments may include Ethernet or wireless local area network (WLAN) segments. These various consumer electronics are typically adapted to be networked with each other. Other network consumer electronics may include, but are not limited to, stereo systems, digital cameras and camcorders, multimedia mobile phones, personal digital assistants, and wireless monitors. This network 150 is typically operably coupled to one or more digital content provider sources, for example, via satellite, cable, and/or terrestrial broadcast 138 or via an external wide area network, such as the Internet 190. Digital content thus may be received from content providers via the Internet 190, through, for example, a gateway router 102, or via broadcasts 138 through a set-top box 134. In this exemplary embodiment, the various consumer electronics conform to the DTCP framework, thereby enabling protected transmission of contents within the home network 150. Other content protection framework may also be used, particularly those that includes data localization as part of its protection scheme. For example, a consumer has requested an on-demand viewing of a certain movie, i.e., the content. This movie content is broadcasted by the satellite 138 and is received by the set-top box 134. The consumer desires to watch that movie at that consumer's DTV 130. The set-top box 134 functions as a source/transmitter while the DTV 130 is a sink/receiver. A proximity detection challenge or test is going to be exchanged between the set-top box 134 and the DTV 130, thereby to ensure that the content is distributed in a local or approximate local area.

MICROSOFT (TM) Windows (TM) Media Digital Rights Management (WMDRM) for network devices, a digital rights management technology, for example, is another digital content protection framework that may apply to some of the embodiments of the present invention. Typically, WMDRM encrypts content and binds the content to the individual device in which the content was first demodulated. Similar to DTCP, WMDRM also implements content localization via proximity detection. WMDRM is another exemplary link level content protection scheme.

In addition to proximity detection, DTCP typically utilizes authentication and key exchange techniques, and content encryption as part of its protection system. Under DTCP, a connected device, e.g., the source, first verifies through the exchange of keys that another connected device, e.g., the sink, is also DTCP-compliant before sharing protected content or data. Digital content may receive varying levels of protection, e.g., “copy-once” or “copy never.” Typically, the digital content is encrypted before or as it is being transported.

The embodiments of the present invention, in one aspect, assigns the highest priority available to at least one port, for example, a logical port such as transmission control protocol (TCP) port or user datagram protocol (UDP), that is utilized to communicate proximity detection or round trip time (RTT) control messages. RTT control messages are typically messages exchanged to detect proximity between two network devices. RTT control messages typically include a message indicating the initiation of an RTT proximity test and a response RTT message indicating the end of that RTT proximity test. In another aspect, some embodiments of the invention assign priorities to proximity control messages, such that these priorities are at least one priority higher than the contents waiting to be transmitted. In another aspect, some embodiments of the invention assign the highest available priority to RTT control messages. Assigning a priority to a port in Internet Protocol (IP) network typically means to have all packets, transmitted through that port, being assigned that priority.

FIG. 2 shows a block diagram of two exemplary devices exchanging content in a protected manner. In the DTCP framework, for example, a sender or transmitter (TX) is typically referred to as a source 202 and a receiver (RX) is typically referred to as a sink 206. In some embodiments, a device may function both as a TX and an RX. A TX is also sometimes referred to as a “media server,” while an RX is sometimes referred to as a “media player.”

A source/TX 202 sends digital content to the sink/RX 206 typically over a network 210. In some exemplary embodiments, the TX or RX may be a DVD recorder, a set-top box, DTV, or a PC. Typically, the TX functions as a media server while the RX functions as a media player, enabling the consumer or user to view or listen to the presented content. Contents transmitted via the network 210 may include various media formats, including, but are not limited to, DivX (TRAMDEMARK), MPEG, AVC/H.264, WMV9, AAC, and JPEG. Such digital content may include videos, e.g., movies, audios, e.g., songs/music, images, or combinations thereof.

In some embodiments, a manner in which the content may be localized is by performing a proximity detection to determine the latency between transmitter 202 and the receiver 206. Typically, a proximity detection test/challenge measures the time difference from the time a media server (TX) sends out the initiate round trip time (RTT) control message and to the time the media server receives a response RTT control message. This proximity detection test to some extent ensures that a digital content, for example, transmitted by a content provider to a home set-top box, is distributed only to a localized area, meaning just the consumer's home, and not to unauthorized consumers, such as by downloading the content to the Internet. If the latency time, e.g., the RTT, meets a defined threshold or condition, e.g., less than 7 ms, the RX is considered near the TX, such that transmission of the content, for example, between the set-top box 134 to a DTV 130 is enabled. This link level protection, for example, may be utilized using DTCP over IP (DTCP-IP) or other content protection digital framework or platform, including WMDRM. In some embodiments, failing to meet the defined latency threshold or condition results in having some conditions or steps to be executed or prevented from being executed—for example, having encrypted data, e.g., a movie content, not being decrypted for viewing by the media player/RX or having encryption keys not exchanged between the TX and the RX.

In some embodiments, a source or TX 202 has typically one or more logical ports 208 associated or integrated with that device. Similarly, a sink or RX 206 has one or more ports 212 associated or integrated with that device 206. In some embodiments of the present invention, the one or more ports 208, 212 are assigned to the digital content protection scheme, similar to the manner hypertext transfer protocol (HTTP) is assigned to port “80.” In some embodiments, a port may be assigned or associated with DTCP or to an applicable content protection scheme utilizing proximity detection.

To further illustrate the embodiments of the present invention, an exemplary DTCP-IP TX 202 has an assigned fixed DTCP port that may be used or accessed for transmission control protocol (TCP) or user datagram protocol (UDP) in the transport layer. This fixed or dedicated port is typically assigned the highest priority. The assignment of the highest priority to this port may be for a limited time, for example, during the exchange of proximity detection or RTT control messages, or may be permanently or indefinitely assigned, for example, by the operating system, by an application, by a standard specification, and the like. The highest priority available typically depends on the framework being used. For example, the Digital Living Network Alliance (DLNA) may define four priorities in its Quality of Service (QOS) access categories, thereby providing DTCP traffic in DLNA to have also four priorities.

For example, to facilitate meeting the RTT condition, e.g., of 7 ms, the RX 206 transmits all RTT control messages, for example, via TCP connections, to the TX 202, or vice versa, through the assigned port with the assigned highest priority, e.g., port 652. By assigning the TCP port highest priority, applications utilizing, for example, DTCP or other digital rights protection schemes, are ensured to having a higher probability of passing the RTT test between the TX and RX. In some embodiments, the port number assigned at the media server side or TX is assigned to a dedicated logical port number, typically for DTCP control traffic.

In other embodiments, the exchange of a set of RTT control messages to determine RTT may be via multiple ports. For example, port A is used by the TX 202 to initiate the RTT test and port B is used by the RX 206 to respond to the RTT initiate request. Typically, these multiple ports are thus each assigned the highest priority, at least during the RTT testing phase. Ports utilized or accessed for proximity detection or RTT tests are typically assigned the highest priority. In some embodiments, assigning a priority to a port, for example, in Internet Protocol (IP) networks typically means to have all packets, transmitted through that port, being assigned that priority.

In other embodiments of the invention, a port or ports, of the present invention, however, are not fixed and may be dynamically assigned, for example, by an application. The port or ports used or activated, in these embodiments, may also be assigned by the application to the highest priority available in the system, thereby having RTT control messages be transmitted at the highest available priority. In some embodiments, the activated or employed ports are exposed, for example, as objects by applications.

In some embodiments of the invention, the RX 206 is a legacy device that does not transmit using a priority scheme. In these exemplary embodiments, only the logical port or ports in the TX 202 side are assigned the appropriate priority as described herein. No priority port or priority scheme is provided by the legacy RX 206. Thus, in this exemplary scenario, the RTT control messages received by the TX 202 do not have any priority setting and are typically not provided any priority service. The TX 202 counterpart, in these exemplary embodiments, however, do employ the priority scheme described herein, while the RX 206 counterpart does not, i.e., the TX 202 utilizes a priority scheme, while the RX 206 does not.

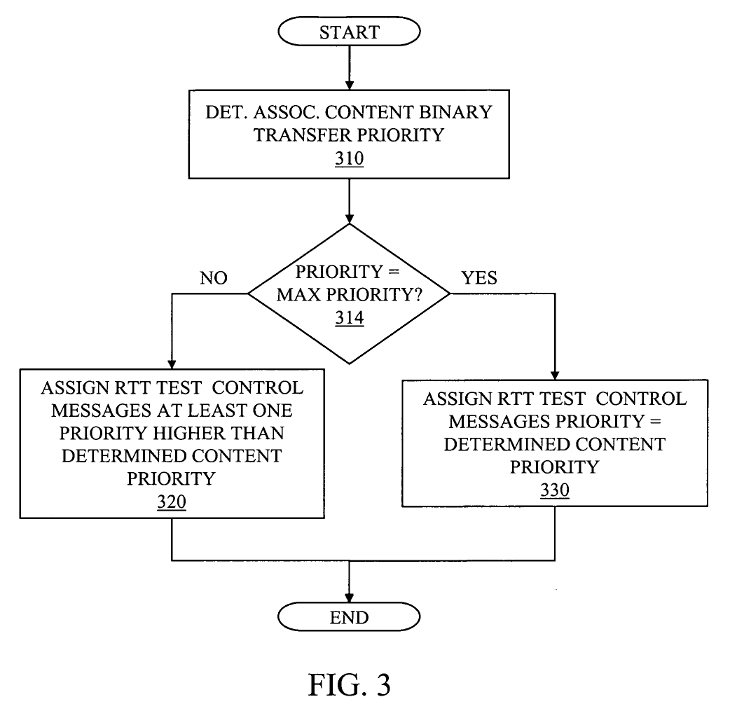

FIG. 3 illustrates another aspect of the invention, wherein the ports are not necessarily assigned the highest priority. FIG. 3 shows a high-level flowchart disclosing an exemplary method of ensuring a higher probability that the RTT commands meet a defined or predefined RTT threshold/condition. In general, the priority of the RTT control messages is assigned a priority not lower than the priority of the content binary transfer. For illustration purposes, a system is designed to transmit content or content elements at four available priorities, with “0” as the lowest priority and “3” as the highest priority. Assuming that the content or content elements waiting to be transmitted and protected is an ANV streaming video, assigned priority “2,” for example. In the first operation, a determination is made as to the priority that is going to be utilized to perform a binary transfer of that content or content elements (step 310). If the priority of the content binary transfer is the maximum priority allocated or available within the system (decision 314), the RTT control messages are assigned the maximum priority (step 330). On the other hand, if the content binary transfer priority is not the maximum priority, the RTT control messages are assigned at least one priority higher than the determined priority defined for the binary transfer of that content. In some other embodiments not shown, the RTT test control messages are set to the highest priority allocated or permitted within the system, without determining the priority of the content to be transmitted.

In some embodiments, however, if the RX 206 is a legacy device that does not employ any priority scheme, the RTT control messages sent by the legacy RX 206 are sent without any priority and. thus, are typically not provided any priority preference. In these exemplary embodiments, however, the TX 202 does transmit RTT control messages at the appropriate priority as described herein, while the counterpart RX 206 does not.

Table I below is a table showing exemplary user priority categories available for Quality of Service (QOS) available by an embodiment of the Digital Living Network Alliance (DLNA). The table shows the exemplary priority from lowest (0) to highest priority (3).

TABLE I
Exemplary DTCP-IP QOS Access Categories.

| Priority Rank | QOS Priority Category | Description |
|---|---|---|
| 0 - Lowest | DLNAQOS_0 | Lowest Priority, typically |
| | | used for background |
| | | transfers |
| 1 - Higher than 0 | DLNAQOS_1 | Default Priority for any |
| | | traffic typically defined by |
| | | DLNA guidelines, unless |
| | | specified otherwise |
| 2 - Higher than 1 | DLNAQOS_2 | Typically for audio/visual |
| | | (A/V) streaming transfers |
| | | and Universal Plug N Play |
| | | (UPnP) network protocol |
| | | transport stream control, |
| | | etc. |
| 3 - Highest | DLNAQOS_3 | Highest Priority, typically |
| | | used for Real-Time |
| | | Transport Protocol Control |
| | | Protocol (RTCP) messages |
| | | generated by content |
| | | receivers |

For illustrative purposes, an AV streaming video is waiting to be transmitted from a source/TX 142 to a sink/RX 164. This AV streaming video, based on the above table, is typically assigned a priority of “2” (step 310). The control messages, to determine the RTT latency between the TX and RX, are therefore assigned at least one priority higher, therefore priority “3.” In some other embodiments not shown, the RTT test control messages are set to the highest priority allocated or permitted within the system, without determining the priority of the content to be transmitted. For example, in an exemplary DTCP-IP framework, all DTCP-IP messages, e.g., Authentication and Key Exchange (AKE) messages, RTT messages, and the like, generated by sources and receivers are tagged as DLNAQOS_3, i.e., the highest priority defined within an embodiment of DLNA QOS. DLNAQOS_3 is also the priority higher than the A/V stream priority. By assigning the highest priority, these messages and/or packets are typically provided the best available network service. In some embodiments, an RTT proximity test is part of AKE. In these exemplary embodiments, the AKE messages are also sent via the same port as the RTT control messages and/or at the same priority as the RTT control messages. For example, the AKE messages are sent at the highest priority or at a priority higher than the A/V stream. These AKE messages are typically messages sent to perform key exchange, validation, and authentication.

In another example, a network has five available priorities, with a value of “0” assigned to the least priority. In this exemplary embodiment, priority of “2” is assigned to transfer images and a priority of “3” is assigned to transfer voice. In these embodiments, the RTT control messages related to the transfer of images are assigned a priority of “3,” while RTT control messages related to voice are assigned a priority of “4”—one higher than the priority for the binary transfer of that content. In other embodiments of this example, the RTT control messages are all assigned the highest priority, i.e., “5,” regardless of whether the transfer is related to images or voice, for example.

FIG. 4 is a diagram of how exemplary RTT control messages are exchanged to determine latency or RTT. This proximity detection challenge illustrates an exemplary DTCP-IP RTT protocol or portion thereof, according to some embodiments of the invention. This RTT proximity detection is typically performed within the challenge-response portion of the authentication and key exchange (AKE) function within the DTCP scheme. Part of DTCP is exchanging cryptographic keys, for example, by the source/TX and the sink/RX such that data for transmission is protected. Typically, in some embodiments, the RTT testing may be performed a certain defined number of times, e.g., 1024 times, before the TX and RX abort, such that encryption keys are not exchanged. In some embodiments, failure to meet the RTT threshold/condition may result in the content not being sent between the TX and RX. In some embodiments, DTCP-IP RTT is limited to 7 milliseconds or less, which typically represents the amount of time that an IP packet and associated responses may travel between devices. In some embodiments, the exchange of RTT control messages may be used to determine if a certain device or RX is to be added to a list of approved or valid RX devices. Other uses or functions of RTT checks may also be used, such as to determine availability of a device, to determine the best device to function as an RX, and the like.

In an exemplary embodiment, an RTT_READY.CMD control message 402 is first sent by the TX 202 to the RX 206. The RTT_READY.CMD 402, 406 is typically a message and command that indicates that the authentication computation, for example, within a DTCP scheme, is complete and that the device is ready to execute the RTT test procedure. An RTT_READY.RSP 404, 408 message is typically a confirming response informing the sender of the RTT_READY.CMD that the recipient of that message is ready or not. The first four messages 402-408, i.e., the exchanges of RTT_READY.CMD and RTT_READY.RSP messages, indicate for our exemplary purpose that the TX and the RX are now ready to execute the RTT test procedure. After this set of exchanges 402-408, the number of retries permitted in the system is then set 412. In some embodiments, each failure of the RTT test is recorded, for example, as an error message. The number of retries may be established by having a value N assigned in the RTT_SETUP.CMD 412 message. N is typically initially set to zero and may range from 0 to a maximum permitted RTT trials, for example, a maximum of 1024 trials, thus, N ranges from 0 to 1023. The number of maximum retries is then accepted by the RX 414. After the N is set, the source or TX 202 then measures the RTT which is the time interval starting typically after TX 202 transmits the RTT_TEST.CMD control message—i.e., the initiate RTT control message, indicating initiation of the proximity test or RTT test, and terminates upon reception of RTT_TEST.RSP accepted response 418—i.e., the response RTT control message indicating completion of the proximity test or RTT test. In some embodiments, there may be a series of control messages exchanged to define one RTT test phase or procedure, i.e., one try. Each RTT test phase, however, is typically delineated by an initiate or initial RTT control message 416 and a response RTT control message 418, as shown. If the RTT does not meet the defined RTT or latency threshold, the RTT phase 416, 418 may be repeated. Each time an RTT test is retried, the number of times a retry is performed is tracked, such that the number of retries does not exceed the maximum number of retries permitted in the system. If the maximum number of retries has been exceeded, the encryption keys or content, for example, are not exchanged.

In some embodiments of the invention, the RTT control messages 416, 418 are sent via the port or ports of the RX and/or TX, wherein the port or ports are each assigned the highest priority according to embodiments of the present invention. For example, port “652” is assigned to DTCP/TCP. The RTT test control messages are thus sent via one connection via this port thereby ensuring the highest priority of the RTT control messages 416, 418.

In another embodiment, the RTT control messages, i.e., the initiate or initial RTT control message 416 and the response RTT control message 418, and any other intervening RTT control messages, if any, that may be read to determine latency, are assigned a priority at least one higher than the binary transfer priority of the content data that may be in a waiting state, waiting to be transmitted or associated with this RTT test phase. Thus, in some embodiments, the other control messages 402, 404, 406, 408, 412, 414 are not allocated a higher priority than they are usually assigned. In some embodiments, a module, for example, a DTCP module in the TX, source or media server, 202 assigns the higher or highest priority for the initiate RTT control message 416, while the RX or media player 206 assigns the higher or highest priority for the response RTT control message 418. In other embodiments, the priority used to transmit the initiate RTT control message 416 is also the same priority used to transmit the response RTT control message 418. In some embodiments, the initiate RTT control message 416 includes the priority to be used by the RX in transmitting its response RTT message 418.

To further clarify, assume we have an A/V content defined to be priority “2,” as shown in Table I above. In some embodiments, before this A/V content is transmitted, an RTT test is performed associated with that A/V content. The RTT control messages 416, 418 are thus transmitted at a priority at least one higher than the A/V content priority, i.e., priority “3.” If the RX and TX are able to send and receive within the RTT defined condition of less than 7 ms, i.e., the latency between RX and TX is less than 7 ms, the TX 202 may then transmit the content associated with the RTT test to the RX 206 at the A/V lower content priority of “2.” In another embodiment of the invention, the RTT control messages, including any intervening control messages related to determining latency, are all assigned at least one priority higher than the associated content.

In another exemplary embodiment, typically all RTT control messages 416, 418, including any intervening RTT control messages, are set to the highest priority available, for example, priority “3,” if using Table I. In this embodiment, there is typically no need to determine the priority of the associated content, considering all RTT control messages are assign the highest priority available. Intervening RTT control messages between the RTT control messages 416, 418 may be any control messages that are exchanged, for example, for other implementation or implementation variation purposes. Examples of intervening RTT control messages (e.g., between RTT control messages 416 and 418), may include request and confirmation messages as part of the RTT_TEST sequence.

Table II below shows exemplary Wi-Fi multimedia (WMM) access categories/priorities, shown lowest to highest priority.

| | | 802.1d |
|---|---|---|
| Access Category | Description | Tags |
| WMM Background | Low Priority Traffic (file downloads, print | 2, 1 |
| Priority | jobs) that does not have strict latency and | |
| | throughput requirements. | |
| WMM Best Effort | Traffic from legacy devices, or traffic | 0, 3 |
| Priority | from applications or devices that lack | |
| | QOS capabilities. Traffic less sensitive to | |
| | latency, but affected by long delays, e.g., | |
| | Internet browsing or surfing. | |
| WMM Video | Prioritize video traffic above other data | 5, 4 |
| Priority | traffic. (One 802.11g or 802.11a channel | |
| | typically supports 3 to 4 standard | |
| | definition television (SDTV) streams or 1 | |
| | high-definition television (HDTV) stream. | |
| WMM Voice | Highest Priority. Enables multiple | 7, 6 |
| Priority | concurrent Voice over IP (VOIP) calls, | |
| | with low latency and toll voice quality. | |

Referring to FIGS. 3 and 4, if WMM priorities are used and the content that is going to be transferred, for example is video, which is assigned “WMM Video Priority,” the initiate/initial RTT control message similar, for example, to the RTT_TEST.CMD 416, may be sent by TX 202 at one priority higher, i.e., sent to the priority equaling to “WMM Voice Priority;” while the receiver may respond with a response RTT control message, for example, similar to ACCEPTED.RSP 418 message, with priority assigned to “WMM Voice Priority.” In some other embodiments, not shown, the packets containing these exemplary control messages 416, 418 are assigned user priority of “7” for an 802.1Q network or have a DiffServ Code Point (DSCP) tag of Ox38.

Although the embodiments of the present invention discussed herein are exemplified using DTCP-IP, the features of the present invention may be applied to other platforms, network protocols, transport protocols, applications, and the like. For example, the embodiments of the present invention may also be performed on systems utilizing WMDRM network devices protocol, but typically with a different set of RTT control messages and parameters being exchanged. Furthermore, the embodiments of the present invention may also apply to various networks, including, but not limited to, 802.11E networks, power line communication networks, Digital Living Network Alliance (DLNA) networks, and non-DLNA networks. The features of the present invention may also apply to other priority-based QOS networks, both wired and wireless, including but not limited to, powerline communication (PLC) networks and BLUETOOTH (TM) networks, i.e., networks using BLUETOOTH (TM) technology. Power line communication (PLC), sometimes also called broadband over power line (BPL), is a wire-based technology—which in particular uses medium and low voltage power lines for data communications. These power line networks include networks created by using electrical wirings, for example, in homes and buildings. Data communicated for example, include, but are not limited to, music, streaming videos, files, voice, databases, text files, control commands, and network keys. BLUETOOTH (TM) networks, similar to PLC networks, are networks currently available and are known to those skilled in the art.

FIG. 5 is a high-level functional block diagram of an exemplary TX, source, or media server 500 according to an embodiment of the invention. A TX 500 may be embodied in many forms as discussed above, including, for example, as a set-top box 134, a computer 142, and a DVD player 160. In some embodiments, a device may function both as a TX and an RX, i.e., the device is adapted to send and receive and/optionally present content.

Typically, a TX 500 includes an input/output (I/O)-communications module 504 that enables the TX 500 to communicate with other devices within the network. Furthermore, depending on the functions of the TX, the I/O communications module 504 may also be adapted to communicate and interface with external networks, such as the Internet 190 or satellite or terrestrial broadcast 138. This capability to communicate with external networks, for example, may be available for set-top boxes that are adapted to receive premium content via cable or through the Internet. This set-top box 134 thus functions as a TX/source because it transmits content, for example, to a sink or media player, such as an HDTV 130. This capability of communicating with external networks, however, may not be present in other TX devices, e.g., a DVD player, wherein content to be transmitted is not provided by an external content provider, but rather through a removable medium, e.g., a DVD or CD that a consumer may placed inside the DVD player.

A TX 500 may also contain a data store 504, permanent and/or temporary, such as hard drive, flash memory, smart drive, RAM, etc. A set-top box 134, for example, may include a data store so as to temporarily or permanently store content, for example, sent by content providers. This data store 504 may also contain other information, such as data-related to the TX device 500, such as time, serial number, program instructions, etc. For a DVD player, for example, the data store 504 may be a removable DVD.

A TX 500 may also include a transmit content module 518 adapted to transmit content, typically protected content, to one or more RX devices. The contents are typically protected using encryption and other protection schemes implemented within the system or protocol.

The TX 500 may also include an authentication and key exchange module 514, adapted to perform authentication and key exchange (AKE)/validation functions. For example, if the TX 500 is DTCP-compliant/certified, the AKE module 514 authenticates the RX, i.e., authenticates the RX device based on the DTCP authentication framework. In some embodiments, this AKE 514 module also performs the exchange of encryption keys with the receiving sink device, such that the sink or receiving device is able to decode and present the protected content sent by the TX 500. This AKE module 514 may also be adapted to perform validation functions, such as background processes to determine whether an RX device is a valid device to which the TX may send content.

The TX 500 also includes an RTT test/challenge module 508 adapted to perform proximity detection or RTT tests as described herein. The RTT test module 518 is typically also adapted to send and receive RTT or proximity control messages. Information related to the RTT test, such as results, may also be communicated with the AKE module 514, such that based on the RTT result, the AKE module may then determine 514, whether an associated content or an encryption key is to be sent.

The priority module 512 is adapted to perform the prioritization of RTT control messages, such as setting and/or determining the priority of RTT control messages that are to be transmitted by the RTT test module 508. In some embodiments, the priority module 512 assigns the highest priority to the port, e.g., DTCP port. In other embodiments, the priority module assigns all RTT control messages to the highest available priority within the framework. In another embodiment, the priority module 512 assigns at least one priority higher than the associated content. In other embodiments, the sink may also perform its own priority determination.

In some embodiments of the invention, the different modules 508, 512, 514, 504, 518 may communicate and interface with each other via a bus, dedicated signal paths or one or more channels 510. Depending on the function of the TX device, other modules, including functions and capabilities, may be added or removed. For example, a set-top box may have a user interface module adapted to present information to the users, such as presenting available premium content for consumers to view and/or purchase. Furthermore, the modules described herein may be combined, such as the RTT test module 508, priority module 512, and AKE module 514 may be combined into one module 520 adapted to perform some or all functions of the various modules. Furthermore, the modules described herein may be further subdivided and combined with other functions so long as the function and processes described herein may be performed. The various modules may also be implemented in hardware, software, or both, i.e., firrnware.

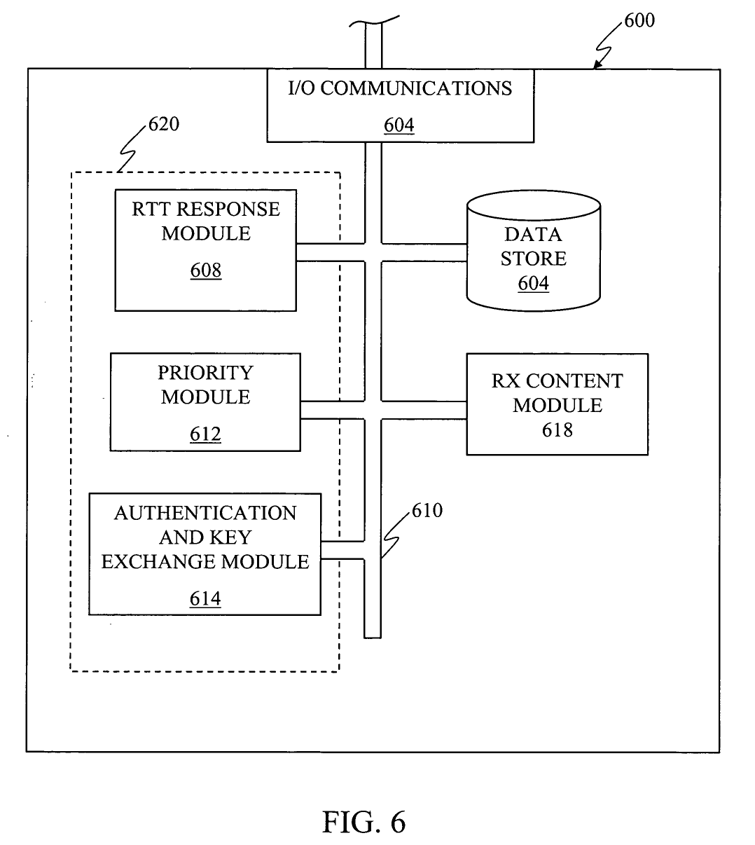

FIG. 6 is an exemplary high-level functional block diagram of an exemplary RX/sink 600 according to an embodiment of the invention. An RX 600 typically includes modules 608, 612, 604, 614 similar to those of the TX 508, 512, 514, 504. Typically, the RX receives content rather than transmit content, and thus it has an RX content module 618 adapted to receive content, typically, transmitted by a TX 500. The RX 600 may also include a data store 608 adapted to store, temporarily or permanently, a received content. The RTT test/challenge module 608 typically performs the function of responding to an initiate RTT control messages sent by TX devices. The priority module 712 typically performs the prioritization features, such as setting the priority of a response RTT control message, e.g., highest priority or at least one priority higher than the priority of the associated content, or establishing a connection with a TX port that is assigned the highest priority. The AKE module 614 typically performs the authentication and key exchange module, typically, depending on the content protection scheme being utilized. The RTT response module 608, priority module 612, and the AKE module 614 may also be combined to one module 620 similar to the above TX 500. Similarly, the modules may be further subdivided and/or combined with other modules. The various modules may also be implemented in hardware, software, or both, e.g., firmware.

Embodiments of the present invention may be used in conjunction with networks, systems, and devices that may employ proximity detection sensors and testing schemes between one or more devices. Although this invention has been disclosed in the context of certain embodiments and examples, it will be understood by those or ordinary skill in the art that the present invention extends beyond the specifically disclosed embodiments to other alternative embodiments and/or uses of the invention and obvious modifications and equivalents thereof. In addition, while a number of variations of the invention have been shown and described in detail, other modifications, which are within the scope of this invention, will be readily apparent to those of ordinary skill in the art based upon this disclosure. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

I claim:

1. A method of proximity detection, the method comprising the steps of:
determining a round trip time (RTT) priority; and
sending at least one RTT control message at the RTT priority, wherein the RTT priority is higher than a best effort.

2. The method of claim 1, further comprising the step of determining a priority of an associated content.

3. The method of claim 1, wherein the determined RTT priority is at a highest priority.

4. The method of claim 3, wherein the step of sending the at least one RTT control message is via an Internet Protocol (IP) as a network layer, and via at least one of the following:
a transport control protocol (TCP) as a transport layer; and
a user datagram protocol (UDP) as a transport layer.

5. The method of claim 1, wherein the at least one RTT control message is at least one of the following:
an initial RTT control message indicating initiation of a proximity test; and
a response RTT control message indicating completion of the proximity test.

6. The method of claim 1, wherein the sending step is via at least one of the following:
a transport control protocol (TCP) as a transport layer; and
a user datagram protocol (UDP) as a transport layer.

7. The method of claim 1, wherein the sending step is via an Internet Protocol (IP) as a network layer.

8. The method of claim 7, wherein the step of sending the at least one RTT control message is via a port wherein the at least one RTT control message is sent, and wherein the port is selected from at least one of the following:
a transport control protocol (TCP) port; and
a user datagram protocol (UDP) port.

9. The method of claim 2, wherein the determined RTT priority is at least one priority higher than the determined associated content priority.

10. The method of claim 9, wherein the determined associated content priority is based on Digital Living Network Alliance (DLNA) Quality of Service priorities.

11. The method of claim 9, wherein the step of sending the at least one RTT control message is via an Internet Protocol (IP) as a network layer, and via at least one of the following:
a transport control protocol (TCP) as a transport layer; and
a user datagram protocol (UDP) as a transport layer.

12. A method of authentication and key exchange (AKE), wherein the AKE is within a digital transmission content protection over Internet Protocol (DTCP-IP) framework, and wherein the AKE includes at least one round trip time (RTT) proximity test, the RTT proximity test comprising at least one RTT control message, the method comprising the steps of:
determining a priority associated with the at least one RTT proximity test, wherein the priority is higher than a best effort; and
sending, via a port at the determined RTT priority, AKE messages comprising the at least one RTT control message.

13. The method of claim 12, wherein the RTT priority is set at a highest priority.

14. The method of claim 12, wherein the RTT priority is based on a priority associated with a content associated with the RTT proximity test.

15. A source device adapted to be operably coupled with at least one receiving device (RX) via a network segment, the device comprising:
a transmit content module adapted to transmit at least one content element, associated with a proximity test, to the at least one RX;
a round trip time (RTT) test module adapted to:
transmit at least one initial RTT control message indicating initiation of the proximity test;
receive at least one response RTT control message in response to the at least one initiate RTT control message, the at least one response RTT control message indicating completion of the proximity test; and
determine at least one RTT based on the at least one transmitted initiate RTT control message and the at least one received response RTT control message; and
a priority module adapted to:
determine at least one priority with which the RTT test module is adapted to transmit the at least one initiate RTT control message, wherein the at least one priority is based on a content priority of the at least one content associated with the proximity test.

16. The source device of claim 15, wherein the RTT test module is further adapted to receive the at least one response RTT control message, wherein the RTT control message has no priority.

17. The source device of claim 15, wherein the determined at least one priority is at least one priority higher than the content priority.

18. The source device of claim 15, wherein the determined at least one priority is at a highest priority when the content priority is also at the highest priority.

19. A source device adapted to be operably coupled with at least one receiving device (RX) via a network segment, the device comprising:
at least one port assigned a highest priority;
a round trip time (RTT) test module adapted to:
transmit at least one initiate RTT control message, indicating initiation of a proximity test, via the at least one port;
receive, via the at least one port, at least one response RTT control message, indicating completion of the proximity test, in response to the at least one initiate RTT control message; and
determine at least one RTT based on the at least one transmitted initiate RTT control message and the at least one received response RTT control message; and
a transmit content module adapted to:
transmit at least one content to the at least one RX based on whether the determined at least one RTT is within a defined RTT condition.

20. The device of claim 19, wherein the at least one port is selected from at least one of the following:
a transport control protocol (TCP) port; and
a user datagram protocol (UDP) port.

21. The source device of claim 19, wherein the RTT test module is further adapted to receive the at least one response RTT control message, wherein the RTT control message has no priority.

22. A source device adapted to be operably coupled with at least one receiving device (RX) via a network segment, the device comprising:
a transmit content module adapted to transmit at least one content element, associated with a proximity test, to the at least one RX; and
a round trip time (RTT) test module adapted to:
transmit, at a highest priority, at least one initiate RTT control message indicating initiation of the proximity test;
receive at least one response RTT control message in response to the at least one initiate RTT control message, the at least one response RTT control message indicating completion of the proximity test; and
determine at least one RTT based on the at least one transmitted initiate RTT control message and the at least one received response RTT control message.

23. The source device of claim 22, wherein the RTT test module is further adapted to receive, at a highest priority, the at least one response RTT control message.

24. The source device of claim 22, wherein the RTT test module is further adapted to receive the at least one response RTT control message with no priority.

25. A receiving device adapted to be operably coupled with at least one transmitting device (TX) via a network segment, the device comprising:
a receive content module adapted to receive at least one content element from the at least one TX, wherein the at least one content element is associated with a proximity test; and
an RTT test module adapted to:
receive at least one initiate RTT control message indicating initiation of the proximity test at an RTT priority, wherein the RTT priority is higher than a best effort; and
transmit at the RTT priority at least one response RTT control message, indicating completion of the proximity test, in response to at least one of the received RTT control messages.

26. The receiving device of claim 25 wherein the RTT priority is at least one priority higher than a content priority associated with the at least one content element associated with the proximity test.

27. The receiving device of claim 25 wherein the RTT priority is at a highest priority.

28. A receiving device adapted to be operably coupled with at least one transmitting device (TX) via a network segment, the device comprising:
a receive content module adapted to receive at least one content element from the at least one TX, wherein the at least one content is associated with a proximity test; and
an RTT test module adapted to:
receive at least one initiate RTT control message indicating initiation of the proximity test, wherein the at least one initiate RTT control message is transmitted via a first port, of the at least one TX, with a first priority;
transmit at the first priority, at least one response RTT control message, indicating completion of the proximity test, in response to the at least one received RTT control message;
wherein the first priority is selected from at least one of the following:
a highest priority; and
a priority higher than a priority of the associated content.

29. The receiving device of claim 28, wherein the first port is selected from at least one of the following:
a transport control protocol (TCP) port; and
a user datagram protocol (UDP) port.

30. The receiving device of claim 28, wherein the RTT test module is further adapted to transmit the at least one response RTT control message via a second port selected from at least one of the following:
a transport control protocol (TCP) port; and
a user datagram protocol (UDP) port.

31. A source device adapted to be operably coupled with at least one receiving device (RX) via a network segment, the device comprising:
a round trip time (RTT) priority module adapted to:
determine a round trip time priority, wherein the RTT priority is higher than a best effort;
transmit at least one RTT control message at the determined RTT priority; and
an authentication and key exchange (AKE) module adapted to:
send AKE messages via a port at the determined RTT priority, wherein at least one of the AKE messages comprises the at least one RTT control message.

32. A receiving device adapted to be operably coupled with at least one transmitting device (TX) via a network segment, the device comprising:
a receive content module adapted to receive at least one content element from the at least one TX, wherein the at least one content element is associated with a proximity test; and
an authentication and key exchange (AKE) module adapted to:
receive AKE messages, wherein at least one of the AKE messages is an initiate RTT control message indicating initiation of the proximity test at an RTT priority, wherein the AKE messages is each received at the RTT priority higher than a best effort; and
transmit at the RTT priority AKE messages.
